(19) United States
(12) Patent Application Publication
(10) Pub. No.: US 2025/0191132 A1
(43) Pub. Date: Jun. 12, 2025

(54) METHOD FOR ARTIFACT REMOVAL OF MEDICAL IMAGE AND DSA SYSTEM

(71) Applicant: Shanghai United Imaging Healthcare Co., Ltd., Shanghai (CN)

(72) Inventors: Liang Yue, Shanghai (CN); Juan Feng, Shanghai (CN); Yang Hu, Shanghai (CN); Chunhua Jiang, Shanghai (CN)

(21) Appl. No.: 18/971,062

(22) Filed: Dec. 6, 2024

(30) Foreign Application Priority Data
Dec. 6, 2023 (CN) 202311668973.8
Dec. 29, 2023 (CN) 202311870297.2

(51) Int. Cl. G06T 5/50; G06T 7/30; G06V 10/25; G06V 10/75

(52) U.S. Cl. CPC G06T 5/50; G06T 7/30; G06V 10/25; G06V 10/759; G06T 2207/20224; G06T 2207/30004; G06V 2201/03

(57) ABSTRACT

A method for artifact removal of a medical image and a DSA system are provided. The method includes: acquiring an image set of a collected position in a target portion, the image set including a mask image and a contrast image in one-to-one correspondence; performing global registration on the mask image and the contrast image of the collected position, and obtaining a first registration result; performing local registration on the image set after the global registration based on the first registration result, and obtaining a corresponding second registration result; and performing subtraction on the image set after the local registration based on the second registration result, and obtaining a subtraction image of the target portion.

### CROSS-REFERENCE TO RELATED APPLICATION

The present disclosure claims priority to Chinese patent applications No. 202311870297.2, filed on Dec. 29, 2023, titled “METHOD AND APPARATUS FOR ARTIFACT REMOVAL OF MEDICAL IMAGE, AND DSA SYSTEM”, and No. 202311668973.8, filed on Dec. 6, 2023, titled “METHOD AND APPARATUS FOR ARTIFACT REMOVAL OF MEDICAL IMAGE, COMPUTER DEVICE, AND STORAGE MEDIUM”, the contents of which are hereby incorporated by reference in their entireties.

### TECHNICAL FIELD

The present disclosure generally relates to the field of image processing, and in particular, to a method for artifact removal of a medical image and a DSA system.

### BACKGROUND

Digital subtraction angiography (DSA) is a medical imaging technology that is configured to observe a structure and a function of a human vascular system, and can provide a vascular image with high resolution and high contrast. A basic principle of the DSA is subtracting images photographed before and after injection of a contrast agent, so as to eliminate interference of structures such as a bone and a soft tissue, to obtain a subtracted image that only includes a vessel. An image photographed before the injection of the contrast agent is referred to as a mask, and an image photographed after the injection of the contrast agent is referred to as a shadow.

During photographing of a body part such as a lower limb, due to constraints of a bed body and a ray plate, photographing and subtraction need to be performed on different positions of a target part by the DSA, and images at different positions are spliced into a complete DSA image. For reasons such as a difference in collection time between a mask and a shadow, a motion artifact often occurs in the DSA image obtained by splicing. However, in the related art, only simple splicing of images at different positions can be implemented, and the artifact in the DSA image cannot be effectively removed, which results in relatively low quality of a vascular image.

For an issue of effective artifact removal in the DSA image, there is no effective solution in the related art.

### SUMMARY

According to various embodiments of the present disclosure, a method for artifact removal of a medical image and a DSA system are provided.

In a first aspect, a method for artifact removal of a medical image is provided, including: acquiring an image set of a collected position in a target portion, performing global registration on the mask image and the contrast image of the collected position, obtaining a first registration result, performing local registration on the image set after the global registration based on the first registration result, and obtaining a corresponding second registration result, performing subtraction on the image set after the local registration based on the second registration result, and obtaining a subtraction image of the target portion. The image set includes a mask image and a contrast image in one-to-one correspondence.

In some embodiments, the mask image is a preprocessed mask image, the contrast image is a preprocessed contrast image, and a preprocessing includes at least one of logarithmic transformation, regularization, normalization, or denoising processing.

In some embodiments, performing the global registration on the mask image and the contrast image of the collected position, and obtaining the first registration result further includes: determining a region of interest in the contrast image, extracting a block image that has a same size as the region of interest in the contrast image from the mask image, matching the block image of the mask image with the region of interest in the contrast image, determining, according to a matching result, an optimal matching position corresponding to the region of interest in the contrast image, determining an offset corresponding to the optimal matching position, performing the global registration on the mask image based on the offset, and obtaining the first registration result. Alternatively, performing the global registration on the mask image and the contrast image of the collected position, and obtaining the first registration result further includes: determining a region of interest in the mask image, extracting a block image that has a same size as the region of interest in the mask image from the contrast image, matching the block image of the contrast image with the region of interest in the mask image, determining, according to a matching result, an optimal matching position corresponding to the region of interest in the mask image, determining an offset corresponding to the optimal matching position, performing the global registration on the contrast image based on the offset, and obtaining the first registration result.

In some embodiments, determining the region of interest in the contrast image further includes: determining a target region in the contrast image according to the target portion, and taking the target region in the contrast image as the region of interest in the contrast image; or determining the region of interest in the contrast image based on information degree of each local region in the contrast image. Alternatively, determining the region of interest in the mask image further includes: determining a target region in the mask image according to the target portion, and taking the target region in the mask image as the region of interest in the mask image; or determining the region of interest in the mask image based on information degree of each local region in the mask image.

In some embodiments, extracting the block image that has the same size as the region of interest in the contrast image from the mask image, and matching the block image of the mask image with the region of interest in the contrast image further includes: processing the mask image by an image searching algorithm, obtaining a plurality of block images of the mask image with the same size as the region of interest in the contrast image, and matching each of the plurality of block images in the mask image with the region of interest in the contrast image. Alternatively, extracting the block image that has the same size as the region of interest in the mask image from the contrast image, and matching the block image of the contrast image with the region of interest in the mask image further includes: processing the contrast image by the image searching algorithm, obtaining a plurality of block images of the contrast image with the same size as the region of interest in the mask image, and matching each of the plurality of block images of the contrast image with the region of interest in the mask image.

In some embodiments, determining the offset corresponding to the optimal matching position, performing the global registration on the mask image based on the offset, and obtaining the first registration result further includes: applying the offset to each pixel in the mask image to obtain the first registration result. Alternatively, determining the offset corresponding to the optimal matching position, performing the global registration on the contrast image based on the offset, and obtaining the first registration result further includes: applying the offset to each pixel in the contrast image to obtain the first registration result.

In some embodiments, determining the offset corresponding to the optimal matching position, performing the global registration on the mask image based on the offset, and obtaining the first registration result further includes: performing boundary extension on the mask image based on a preset maximum offset, performing, based on the offset corresponding to the optimal matching position, registration on the mask image after the boundary extension, and obtaining the first registration result. Alternatively, determining the offset corresponding to the optimal matching position, and performing the global registration on the contrast image based on the offset, and obtaining the first registration result further includes: performing boundary extension on the contrast image based on a preset maximum offset, performing, based on the offset corresponding to the optimal matching position, registration on the contrast image after the boundary extension, and obtaining the first registration result.

In some embodiments, performing the local registration on the image set after the global registration based on the first registration result, and obtaining the corresponding second registration result further includes: performing, based on the first registration result, block matching on the mask image and the contrast image after the global registration according to a preset image control point, obtaining a local region correspondence between the mask image and the contrast image after the global registration, performing, based on the local region correspondence, registration on the mask image and the contrast image after the global registration, and obtaining the corresponding second registration result. The local region includes the preset image control point.

In some embodiments, performing subtraction on the image set after the local registration based on the second registration result, and obtaining the subtraction image of the target portion further includes: splicing a plurality of contrast images into an overall image of the target portion, performing subtraction on the overall image based on the second registration result, and obtaining the subtraction image of the target portion; or performing, based on the second registration result, subtraction on the plurality of contrast images, splicing the plurality of contrast images after subtraction, and obtaining the subtraction image of the target portion. There are a plurality of collected positions, which are corresponding to a plurality of mask images and a plurality of contrast images, respectively. Alternatively, performing subtraction on the image set after the local registration based on the second registration result, and obtaining the subtraction image of the target portion further includes: splicing the plurality of mask images into an overall image of the target portion, performing subtraction on the overall image based on the second registration result, and obtaining the subtraction image of the target portion; or performing, based on the second registration result, subtraction on the plurality of mask images, splicing the plurality of mask images after subtraction, and obtaining the subtraction image of the target portion.

In some embodiments, acquiring the image set of the collected position in the target portion further includes: acquiring a plurality of frames of mask images and a plurality of frames of contrast images at a same collected position. Performing the global registration on the mask image and the contrast image of the collected position, and obtaining the first registration result further includes: performing the global registration on each of the plurality of frames of mask images and each of the plurality of frames of contrast images to obtain a plurality of groups of mask images and contrast images after the global registration, calculating similarity between the mask image and the contrast image in each of the plurality of groups of mask images and contrast images, and selecting a mask image and a contrast image with the highest similarity as the mask image and the contrast image after the global registration at the collected position, respectively.

In a second aspect, another method for artifact removal of a medical image is provided, including: acquiring a first mask image and a first contrast image of a collected position in a target portion, performing global registration on the first mask image based on a region of interest in the first contrast image, and obtaining a second mask image, performing local registration on the second mask image and the first contrast image, obtaining a target mask image corresponding to the collected position, performing subtraction on the first contrast image based on the target mask image, and obtaining a subtraction image of the target portion.

In some embodiments, the first mask image is a preprocessed mask image, the first contrast image is a preprocessed contrast image, and a preprocessing includes at least one of logarithmic transformation, regularization, normalization, or denoising processing.

In some embodiments, performing the global registration on the first mask image based on the region of interest in the first contrast image, and obtaining the second mask image further includes: determining the region of interest in the first contrast image, extracting a block image that has a same size as the region of interest in the first contrast image from the first mask image, and matching the block image of the first mask image with the region of interest in the first contrast image, determining, according to a matching result, an optimal matching position corresponding to the region of interest in the first contrast image, determining an offset corresponding to the optimal matching position, performing the global registration on the first mask image based on the offset, and obtaining the second mask image.

In some embodiments, determining the region of interest in the first contrast image further includes: determining a target region in the first contrast image according to the target portion, and taking the target region in the first contrast image as the region of interest in the first contrast image; or determining the region of interest in the first contrast image based on information degree of each local region in the first contrast image.

In some embodiments, extracting the block image that has the same size as the region of interest in the first contrast image from the first mask image, and matching the block image of the first mask image with the region of interest in the first contrast image further includes: processing the first mask image by an image searching algorithm, obtaining a plurality of block images of the first mask image with the same size as the region of interest in the first contrast image, and matching each of the plurality of block images of the first mask image with the region of interest in the first contrast image.

In some embodiments, determining the offset corresponding to the optimal matching position, performing the global registration on the first mask image based on the offset, and obtaining the second mask image further includes: applying the offset to each pixel in the first mask image to obtain the second mask image.

In some embodiments, determining the offset corresponding to the optimal matching position, performing the global registration on the first mask image based on the offset, and obtaining the second mask image further includes: performing boundary extension on the first mask image based on a preset maximum offset, and performing, based on the offset corresponding to the optimal matching position, registration on the first mask image after the boundary extension, and obtaining the second mask image.

In some embodiments, performing the local registration on the second mask image and the first contrast image, and obtaining the target mask image corresponding to the collected position further includes: performing block matching on the second mask image and the first contrast image according to a preset image control point, obtaining a local region correspondence between the second mask image and the first contrast image, wherein the local region comprises the preset image control point, performing, based on the local region correspondence, registration on the second mask image and the first contrast image, and obtaining the target mask image corresponding to the collected position.

In some embodiments, performing subtraction on the first contrast image based on the target mask image, and obtaining the subtraction image of the target portion further includes: splicing a plurality of first contrast images into an overall contrast image of the target portion, performing subtraction on the overall contrast image based on the target mask image corresponding to each of a plurality of collected positions, and obtaining the subtraction image of the target portion. The plurality of collected positions are corresponding to the plurality of target mask images and the plurality of first contrast images, respectively. Alternatively, performing subtraction on the first contrast image based on the target mask image, and obtaining the subtraction image of the target portion further includes: performing, based on a plurality of target mask images, subtraction on the plurality of first contrast images, splicing the plurality of first contrast images after the subtraction, and obtaining the subtraction image of the target portion.

In a third aspect, an apparatus for artifact removal of a medical image is provided, including: means for acquiring an image set of a collected position in a target portion; means for performing global registration on the mask image and the contrast image of the collected position, and obtaining a first registration result; means for performing local registration on the image set after the global registration based on the first registration result, and obtaining a corresponding second registration result; and means for performing subtraction on the image set after the local registration based on the second registration result, and obtaining a subtraction image of the target portion. The image set includes a mask image and a contrast image in one-to-one correspondence.

In a third aspect, a DSA system is provided, including a DSA device and a processing device. The processing device is configured to implement the method in the first aspect.

Details of one or more embodiments of the present disclosure are set forth in the following accompanying drawings and description. Other features, objectives, and advantages of the present disclosure become obvious with reference to the specification, the accompanying drawings, and the claims.

### BRIEF DESCRIPTION OF THE DRAWINGS

In order to more clearly illustrate the technical solutions in the embodiments of the present disclosure or the related technology, the accompanying drawings to be used in the description of the embodiments or the related technology will be briefly introduced below, and it will be obvious that the accompanying drawings in the following description are only some of the embodiments of the present disclosure, and that, for one skilled in the art, other accompanying drawings can be obtained based on these accompanying drawings without putting in creative labor.

FIG. 1 is a block diagram of a hardware structure of a terminal device for a method for artifact removal of a medical image in an embodiment of the present disclosure.

FIG. 2 is a schematic diagram of a DSA system in an embodiment of the present disclosure.

FIG. 3 is a flowchart of a method for artifact removal of a medical image in an embodiment of the present disclosure.

FIG. 4 is a flowchart of a method for artifact removal of a medical image in an alternative embodiment of the present disclosure.

FIG. 5 is a schematic diagram of an apparatus for artifact removal of a medical image in an embodiment of the present disclosure.

In the figures, 102 represents a processor, 104 represents a memory, 106 represents a transmission device, 108 represents an input/output device, 110 represents a DSA device, 111 represents an examination bed, 112 represents a rack, 113 represents a robot arm, 114 represents an X-ray transmitter, 115 represents an X-ray detector, 120 represents a processing device, 10 represents a collecting module, 20 represents a matching module, 30 represents a registration module, 40 represents a subtraction module.

### DETAILED DESCRIPTION OF THE EMBODIMENT

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure, but not all of the embodiments. Based on the embodiments in the present disclosure, all other embodiments obtained by one skilled in the art without making creative labor fall within the scope of protection of the present disclosure.

Unless defined otherwise, technical terms or scientific terms involved in the present disclosure have the same meanings as would generally understood by one skilled in the technical field of the present disclosure. In the present disclosure, “a”, “an”, “one”, “the”, and other similar words do not indicate a quantitative limitation, which may be singular or plural. The terms such as “comprise”, “include”, “have”, and any variants thereof involved in the present disclosure are intended to cover a non-exclusive inclusion. For example, processes, methods, systems, products, or devices including a series of steps or modules (units) are not limited to these steps or modules (units) listed, and may include other steps or modules (units) not listed, or may include other steps or modules (units) inherent to these processes, methods, systems, products, or devices. Words such as “join”, “connect”, “couple”, and the like involved in the present disclosure are not limited to physical or mechanical connections, and may include electrical connections, whether direct or indirect. “A plurality of” involved in the present disclosure means two or more. The term “and/or” describes an association relationship between associated objects and represents that three relationships may exist. For example, A and/or B may represent the following three cases: only A exists, both A and B exist, and only B exists. Generally, the character “/” indicates an “or” relationship between the associated objects. The terms “first”, “second”, “third”, and the like involved in the present disclosure are only intended to distinguish similar objects and do not represent specific ordering of the objects.

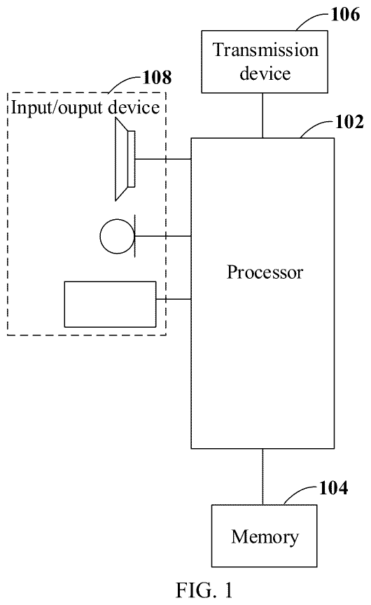

The method embodiment provided in the present disclosure may be executed in a terminal, a computer, or a similar operation apparatus. For example, the method may be executed on a terminal, and FIG. 1 is a block diagram of a hardware structure of a terminal for a method for artifact removal in present embodiment. Referring to FIG. 1, the terminal may include one or more processors 102 (only one processor is shown in FIG. 1) and a memory 104 configured to store data. The processor 102 may include but is not limited to a processing apparatus such as a MCU (Microcontroller Unit) or a FPGA (Field Programmable Gate Array). The foregoing terminal may further include a transmission device 106 and an input/output device 108 that are configured for a communications function. One skilled in the art may understand that the structure shown in FIG. 1 is merely an example, and does not impose a limitation on the structure of the foregoing terminal. For example, the terminal may further include more or fewer components than those shown in FIG. 1, or have different configurations from those shown in FIG. 1.

The memory 104 may be configured to store a computer program, for example, a software program of application software and module, such as a computer program corresponding to a method for artifact removal of a medical image in the present embodiment. The processor 102 executes various functional applications and data processing by running a computer program stored in the memory 104, i.e., implements the foregoing method. The memory 104 may include a high-speed random-access memory, and may further include a non-volatile memory, such as one or more magnetic storage apparatuses, a flash memory, or another non-volatile solid-state memory. In some embodiments, the memory 104 may further include a memory remotely disposed relative to the processor 102, which may be connected to a terminal via a network. Examples of the foregoing network may include but is not limited to the Internet, an intranet, a local area network, a mobile communication network, and a combination thereof.

The transmission device 106 is configured to receive or send data by a network. The foregoing network may include a wireless network provided by a communication provider of a terminal. In an embodiment, the transmission device 106 may include a Network Interface Controller (NIC), which may be connected to another network device via a base station, so as to communicate with the Internet. In an embodiment, the transmission device 106 may be a Radio Frequency (RF) module that is configured to communicate with the Internet in a wireless manner.

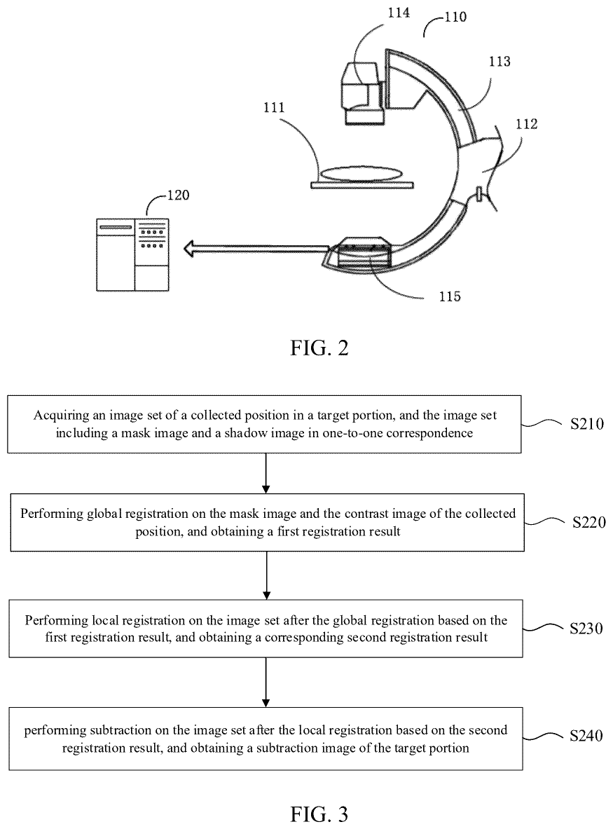

FIG. 2 is a schematic diagram of a DSA system in an embodiment of the present disclosure. Referring to FIG. 2, the DSA system includes a DSA device 110 and a processing device 120. The DSA device may include an examination bed 111, a rack 112, a robot arm 113 (a C-shaped arm shown in FIG. 1) which is disposed on the rack 112, and an X-ray transmitter 114 and an X-ray detector 115 disposed on both ends of the robot arm 113 respectively. The processing device 120 is connected to the X-ray detector 115, and is configured to acquire a contrast image and a mask image collected by the X-ray detector 115. The rack 112 may rotate around each axial direction of the space, and the robot arm 113 may slide on the rack 112.

In a process of performing angiography, a subject may lie flat on the examination bed 111. When the rack 112 drives the robot arm 113 to move to a target position and/or the robot arm 113 slides on the rack 112 to the target position, the X-ray transmitter 114 is configured to transmit X-rays, and the corresponding X-ray detector 115 is configured to convert the X-rays into an electrical signal after detecting the X-rays, and output the electrical signal to the processing device 120. Before a contrast agent is injected into the subject, the X-ray detector 115 may collect a mask image of the subject. After a certain dose of the contrast agent is injected into the subject by a contrast agent syringe, the X-ray detector 115 may collect a contrast image of the subject. Alternatively, when the mask image and the contrast image of the same collected position are acquired, a scanning parameter of the mask image is consistent with a scanning parameter of the contrast image, which facilitates subsequent image subtraction processing.

In an embodiment, a method for artifact removal of a medical image is provided. FIG. 3 is a flowchart of a method for artifact removal of a medical image in the present embodiment. Referring to FIG. 3, the method includes step 210 to step 240.

Step 210 includes that acquiring an image set of a collected position in a target portion. The image set includes a mask image and a contrast image in one-to-one correspondence.

Specifically, for the collected position in the target portion, a first mask image and a first contrast image that are corresponding to the collected position may be acquired. It should be noted that the quantity of the collected position is one or more, for example, N collected positions may be preset on the target portion. In the present embodiment, images of the collected position may be collected step-by-step, and at least one frame of the mask image and at least one frame of the contrast image of i-th (1≤i≤N) collected position may be acquired in order. The mask image may be an image photographed before the contrast agent is injected, and the contrast image may be an image photographed after the contrast agent is injected.

Step 220 includes that performing global registration on the mask image and the contrast image of the collected position, and obtaining a first registration result.

In the present embodiment, global registration may be performed on the mask image based on the contrast image of the collected position, or global registration may be performed on the contrast image based on the mask image of the collected position. Specifically, when the mask image is taken as a converting object, a region of interest in the contrast image may be determined, the mask image may be traversed and a block image with the same size as the region of interest may be extracted from the mask image, the block image may be matched with the region of interest, a block image with the highest similarity to the region of interest may be screened out from the mask image, and a position of the block image with the highest similarity may be an optimal matching position. Then, a corresponding offset may be calculated according to the optimal matching position, and global registration may be performed on the mask image based on the offset to obtain the first registration result, i.e., the mask image after global registration.

When the contrast image is taken as a converting object, a region of interest in the mask image may be determined, the contrast image may be traversed and a block image with a same size as the region of interest may be extracted from the contrast image, and the block image may be matched with the region of interest. Then, an optimal matching position corresponding to the region of interest may be determined according to a matching result, an offset corresponding to the optimal matching position may be determined, and global registration may be performed on the contrast image based on the offset to obtain the first registration result, i.e., the contrast image after global registration.

Furthermore, A plurality of frames of mask images and a plurality of frames of contrast images may be acquired at a same collected position, and all frames of mask images at the same collected position may be corresponding to all frames of contrast images at the same location, i.e., a frame of mask image may be corresponding to a plurality of frames of contrast images. Similarly, a frame of contrast image may be corresponding to a plurality of frames of mask images. Global registration may be performed on the plurality of frames of mask images and a plurality of frames of contrast images, i.e., arrangement group combination and global registration may be performed on each of all mask images of the same collected position and each of all contrast images of the same collected position, and a plurality of groups of mask images and contrast images after the global registration may be obtained. During the global registration, the offset may be applied to a corresponding mask image to obtain the mask image after the global registration, or the offset may be applied to a corresponding contrast image to obtain the contrast after the global registration. Similarity between the mask image and the contrast image in each of the plurality of groups of mask images and contrast images after the global registration may be calculated, and selecting a mask image and a contrast image with the highest similarity as the mask image and the contrast image after the global registration at the collected position, respectively.

Step 230 includes that performing local registration on the image set after the global registration based on the first registration result, and obtaining a corresponding second registration result.

In the present embodiment, the image set after the global registration may include the mask image after the global registration or the contrast image after the global registration. The local registration may be performed on the contrast image after the global registration and the mask image in the image set, or the local registration may be performed on the mask image after the global registration and the contrast image in the image set. Specifically, when the mask image after the global registration is taken as a converting object, block matching may be performed on the mask image after global registration and the contrast image according to a preset image control point to obtain a local region correspondence between the mask image after the global registration and the contrast image, and the preset image control point is in the local region. Furthermore, registration may be performed, based on the local region correspondence, on the mask image after the global registration and the contrast image to obtain the corresponding second registration result, i.e., the mask image after global registration may be converted into a target mask image. Alternatively, fitting may be performed on the local region correspondence between the mask image after the global registration and the contrast image, to obtain a registration matrix between the mask image after the global registration and the contrast image. The registration matrix may include an offset corresponding to each pixel in the mask image after the global registration. Furthermore, the quantity of the image control point may be one or more, one image control point may be corresponding to one local region, or a plurality of image control points may be corresponding to one local region, and the quantity of the local region may be one or more.

When the contrast image after the global registration is taken as a converting object, block matching may be performed on the contrast image after global registration and the mask image according to a preset image control point to obtain a local region correspondence between the contrast image after the global registration and the mask image, and the preset image control point is in the local region. Furthermore, registration may be performed, based on the local region correspondence, on the contrast image after the global registration and the mask image to obtain the corresponding second registration result, i.e., the contrast image after global registration may be converted into a target contrast image. Alternatively, fitting may be performed on the local region correspondence between the contrast image after the global registration and the mask image, to obtain a registration matrix between the contrast image after the global registration and the mask image. The registration matrix may include an offset corresponding to each pixel in the contrast image after the global registration. Furthermore, the quantity of the image control point may be one or more, one image control point may be corresponding to one local region, or a plurality of image control points may be corresponding to one local region, and the quantity of the local region may be one or more.

It should be noted that, in the global registration and the local registration, the mask image may be selected as the converting object with priority compared with the contrast image selected as the converting object. Essence of DSA registration is a vessel subtraction process, the mask image is an image photographed before the contrast agent is injected, the image obtained after the contrast agent is injected, and difference between the mask image and the contrast image is that a vessel cannot be observed from the mask image, and the contrast image includes an obvious vessel. Therefore, based on the difference between the mask image and the contrast image, registration needs to be performed on the mask image and the contrast image. In a practical application scenario, a position of the vessel reflected in the contrast image may be a real position of the vessel. When the contrast image is taken as a converting object for registration, a current position of the real vessel may be changed, resulting in reducing accuracy of vessel detection.

Step 240 includes that performing subtraction on the image set after the local registration based on the second registration result, and obtaining a subtraction image of the target portion.

Specifically, the image set after the local registration may include the mask image after the local registration or the contrast image after the local registration. The subtraction may be performed on the contrast image by the mask image after the local registration to obtain a subtracted image of the target portion, or the subtraction may be performed on the mask image by the contrast image after the local registration to obtain a subtracted image of the target portion.

The quantity of the collected position may be more than one, which are corresponding to a plurality of mask images and a plurality of contrast images. A complete subtraction image may be acquired in a manner of splicing before subtraction. The plurality of contrast images may be spliced into an overall contrast image of the target portion, a plurality of target mask images corresponding to a plurality of collected positions may be spliced into an overall mask image, and the subtraction may be performed on the overall contrast image based on the overall mask image, to obtain the subtraction image of the target portion. Alternatively, the plurality of mask images may be spliced into an overall mask image of the target portion, a plurality of target contrast images corresponding to a plurality of collected positions may be spliced into an overall contrast image, and the subtraction may be performed on the overall mask image based on the overall contrast image, to obtain the subtraction image of the target portion.

In addition, a manner of splicing after subtraction may be applied. Subtraction may be performed on the contrast images based on corresponding target mask images, or subtraction may be performed on the mask images based on corresponding target contrast image, so as to eliminate interference of structures such as a bone and a soft tissue, and contrast images or mask images after the subtraction may be spliced to obtain the subtraction image of the target portion.

Currently, during photographing of a body part such as a lower limb, due to constraints of a bed body and a ray plate, photographing and subtraction need to be performed on different positions of a target part by the DSA, and images at different positions are spliced into a complete DSA image. For reasons such as a difference in collection time between a mask and a shadow, a motion artifact often occurs in the DSA image obtained by splicing. However, in the related art, only simple splicing of images at different positions can be implemented, and the artifact in the DSA image cannot be effectively removed, which results in relatively low quality of a vascular image.

Compared with the related art, in the present disclosure, the image set of the collected position in the target portion is acquired, and the image set includes the mask image and the contrast image in one-to-one correspondence. Global registration is performed on the mask image and the contrast image of the collected position to obtain the first registration result. Local registration is performed on the image set after the global registration based on the first registration result to obtain the corresponding second registration result. Subtraction is performed on the image set after the local registration based on the second registration result to obtain the subtraction image of the target portion. Global registration and local registration are performed on the images of the collected position, and the images are corrected according to the registration result, so that accurate subtraction can be implemented based on the corrected images. This resolves a problem that artifacts in the DSA image cannot be effectively removed, thereby implementing artifact removal of the images and improving quality of a vessel image.

In some embodiments, the mask image may be a preprocessed mask image, the contrast image may be a preprocessed contrast image, and a preprocessing may include at least one of logarithmic transformation, regularization, normalization, or denoising processing.

Specifically, the mask image and the contrast image of the i-th collected position may be acquired, and the mask image and the contrast image may be preprocessed, respectively. A preprocessing method in the present embodiment may include, but is not limited to, logarithmic transformation, regularization, normalization, or denoising processing, one or more of which may be selected to process the images. Subsequent global registration may be based on preprocessed images.

It should be learned that, the logarithmic transformation is configured to convert a collected image from an exponential field to a linear field. A scanning parameter of the mask image may be the same as that of the contrast image, and the mask image and the contrast image may be at a same gray level. In a case that a patient is not moving, a vessel structure may be obtained by subtracting the preprocessed mask image and the preprocessed contrast image, and other structures may not be included.

In addition, in the present embodiment, operations such as regularization, normalization, and denoising processing may be adapted to an image registration method selected practically, so that targeted preprocessing may be performed on the mask image and the contrast image based on the current image registration method, and the mask image and the contrast image may be at the same gray level, thereby improving accuracy and quality of image registration, and significantly improving registration effect.

In the present embodiment, the mask image and the contrast image of the collected position may be acquired, and the mask image and the contrast image may be preprocessed, respectively, so that the images may be converted from the exponential field to the linear field, so that a detail level of the converted images may be clearer to optimize a subsequent image registration result.

In some embodiments, performing global registration on the mask image and the contrast image of the collected position, and obtaining the first registration result may further include: determining a region of interest in the contrast image, extracting a block image that has a same size as the region of interest in the contrast image from the mask image, matching the block image of the mask image with the region of interest in the contrast image, determining, according to a matching result, an optimal matching position corresponding to the region of interest in the contrast image, determining an offset corresponding to the optimal matching position, performing the global registration on the mask image based on the offset, and obtaining the first registration result.

Specifically, a region of interest (ROI) in the contrast image may be selected, and a size of the region of interest may be t (0<t≤1) times of that of the contrast image. A specific value of t may be selected according to historical experience information. The mask image and the region of interest in the contrast image may be processed in a block matching manner, the block image that has the same size as the region of interest in the contrast image may be extracted from the mask image, and the block image of the mask image and the region of interest in the contrast image may be matched.

Furthermore, the optimal matching position corresponding to the region of interest in the contrast image may be determined according to the matching result of the mask image and the region of interest, i.e., a position of a region that is most similar to the region of interest may be selected from the mask image. Then, a distance between the optimal matching position and the region of interest may be calculated as the offset, and the global registration may be performed on the mask image based on the offset to obtain the first registration result, i.e., the mask image after the global registration. Alternatively, when a distance between the optimal matching position and the region of interest is calculated, a distance between a center of the optimal matching position and a center of the region of interest may be selected, or a distance between other corresponding pixels may be selected.

Alternatively, performing global registration on the mask image and the contrast image of the collected position, and obtaining the first registration result may further include: determining a region of interest in the mask image, extracting a block image that has a same size as the region of interest in the mask image from the contrast image, matching the block image of the contrast image with the region of interest in the mask image, determining, according to a matching result, an optimal matching position corresponding to the region of interest in the mask image, determining an offset corresponding to the optimal matching position, performing the global registration on the contrast image based on the offset, and obtaining the first registration result.

Specifically, a region of interest (ROI) in the mask image may be selected, and a size of the region of interest may be t (0<t≤1) times of that of the mask image. A specific value of t may be selected according to historical experience information. The contrast image and the region of interest in the mask image may be processed in a block matching manner, the block image that has the same size as the region of interest in the mask image may be extracted from the contrast image, and the block image of the contrast image and the region of interest in the mask image may be matched.

Furthermore, the optimal matching position corresponding to the region of interest in the mask image may be determined according to the matching result of the contrast image and the region of interest, i.e., a position of a region that is most similar to the region of interest may be selected from the contrast image. Then, a distance between the optimal matching position and the region of interest may be calculated as the offset, and the global registration may be performed on the contrast image based on the offset to obtain the first registration result, i.e., the contrast image after global registration.

It should be noted that, to resolve a problem of a motion artifact generated from a rack jitter in a DSA step-by-step scanning process, a global registration algorithm used in the present embodiment may perform registration calculation based on the region of interest. A common registration method may perform global calculation based on a feature point, and a feature structure of an image may be used. For an overall offset caused by a bed motion and the rack jitter in the DSA step-by-step scanning process, the global registration algorithm based on the region of interest may achieve a better registration effect than a global registration algorithm based on the feature point.

In the present embodiment, the global registration may be performed on the mask image and the contrast image of the collected position to obtain the first registration result, and the mask image or the contrast image may be taken as the converting object, so as to correct an image offset caused by factors such as rack shaking and subject movement.

In some embodiments, determining the region of interest in the contrast image may further include: determining a target region in the contrast image according to the target portion, and taking the target region as the region of interest; or determining the region of interest in the contrast image based on information degree of each local region in the contrast image.

Specifically, an image region corresponding to the target portion may be selected as the target region in the contrast image, and the target region may be the region of interest of the contrast image. For example, when the target portion is a liver, a liver region in the image may be selected as the region of interest. Meanwhile, a region with a size of t (0<t≤1) times of the contrast image may be selected as the region of interest in the center of the contrast image.

In addition, when determining the region of interest in the contrast image, information degree of each local region in the contrast image may be combined. Firstly, information entropy of different regions in the contrast image may be calculated, or a feature extraction algorithm may be used to process the image to obtain a corresponding information template, so that a region with a large amount of information in the contrast image may be preliminarily screened out by the information entropy or the information template, and the region may be selected multiple times to extract a required region of interest.

Alternatively, determining the region of interest in the mask image may further include: determining a target region in the mask image according to the target portion, and taking the target region as the region of interest; or determining the region of interest in the mask image based on information degree of each local region in the mask image.

Specifically, an image region corresponding to the target portion may be selected as the target region in the mask image, and the target region may be the region of interest of the mask image. For example, when the target portion is a liver, a liver region in the image may be selected as the region of interest. Meanwhile, a region with a size of t (0<t≤1) times of the mask image may be selected as the region of interest in the center of the mask image.

In addition, when determining the region of interest in the mask image, information degree of each local region in the mask image may be combined. Firstly, information entropy of different regions in the mask image may be calculated, or a feature extraction algorithm may be used to process the image to obtain a corresponding information template, so that a region with a large amount of information in the mask image may be preliminarily screened out by the information entropy or the information template, and the region may be selected multiple times to extract a required region of interest.

In the present embodiment, the target region may be determined according to the target portion, and the target region may be taken as the region of interest. Alternatively, the region of interest may be determined based on information degree of each local region in the images, so as to select the region of interest accurately.

In some embodiments, extracting the block image that has the same size as the region of interest in the contrast image from the mask image, and matching the block image of the mask image with the region of interest in the contrast image may further include: processing the mask image by an image searching algorithm, obtaining a plurality of block images of the mask image with the same size as the region of interest in the contrast image, and matching each of the plurality of block images in the mask image with the region of interest in the contrast image.

Specifically, when the mask image is matched with the region of interest, the mask image may be processed by the image searching algorithm to obtain the plurality of block images with the same size as the region of interest. The image searching algorithm in the present embodiment may include, but not limited to, a full traversal searching method, a three-step searching method, a four-step searching method, or a diamond searching method.

Furthermore, each of the plurality of block images may be matched with the region of interest, and a region that is most similar to the region of interest may be filtered from the mask image. A position of the region may be the optimal matching position, so that the offset of the image may be obtained according to the optimal matching position and the region of interest.

Alternatively, extracting the block image that has the same size as the region of interest in the mask image from the contrast image, and matching the block image of the contrast image with the region of interest in the mask image may further include: processing the contrast image by the image searching algorithm, obtaining a plurality of block images of the contrast image with the same size as the region of interest in the mask image, and matching each of the plurality of block images in the contrast image with the region of interest in the mask image.

Specifically, when the contrast image is matched with the region of interest, the contrast image may be processed by the image searching algorithm to obtain the plurality of block images with the same size as the region of interest. The image searching algorithm in the present embodiment may include, but not limited to, a full traversal searching method, a three-step searching method, a four-step searching method, or a diamond searching method.

Furthermore, each of the plurality of block images may be matched with the region of interest, and a region that is most similar to the region of interest may be filtered from the contrast image. A position of the region may be the optimal matching position, so that the offset of the image may be obtained according to the optimal matching position and the region of interest.

In the present embodiment, the mask image or the contrast image may be processed by the image searching algorithm to obtain the plurality of block images with the same size as the region of interest, and each of the plurality of block images may be matched with the region of interest, so as to acquire the offset of the image and improve accuracy of image correction.

In some embodiments, determining the offset corresponding to the optimal matching position, performing the global registration on the mask image based on the offset, and obtaining the first registration result may further include: applying the offset to each pixel in the mask image to obtain the first registration result. Alternatively, determining the offset corresponding to the optimal matching position, performing the global registration on the contrast image based on the offset, and obtaining the first registration result may further include: applying the offset to each pixel in the contrast image to obtain the first registration result.

In some embodiments, determining the offset corresponding to the optimal matching position, performing global registration on the mask image based on the offset, and obtaining the first registration result may further include: performing boundary extension on the mask image based on a preset maximum offset, performing, based on the offset, registration on the mask image after boundary extension, and obtaining the first registration result.

Furthermore, based on a preset maximum offset, the boundary extension may be performed on the mask image in a symmetric mapping manner, i.e., on a boundary of the mask image, pixel values of image symmetry may be used to fill an expanded region, and each side of the mask image may be expanded to a maximum offset, so as to avoid a blank region appearing when the mask image after global registration is translated and selected. Alternatively, the preset maximum offset may also be the above calculated offset. In other words, the boundary extension may be performed on the mask image based on the offset corresponding to the optimal matching position.

After that, registration may be performed on the mask image after boundary extension according to the calculated offset, i.e., the mask image after the global registration. For example, when the distance between the optimal matching position in the mask image and the region of interest in the contrast image is (1, 3), 1 represents a horizontal distance, and 3 represents a vertical distance, it may indicate that the offset of the current mask image is (1, 3). In the mask image after boundary extension, the offset (1, 3) may be applied to each pixel of the mask image after boundary extension, i.e., total offset (1, 3) may be performed on the mask image after boundary extension to obtain the mask image after the global registration.

Alternatively, determining the offset corresponding to the optimal matching position, and performing global registration on the contrast image based on the offset, and obtaining the first registration result may further include: performing boundary extension on the contrast image based on a preset maximum offset, performing, based on the offset, registration on the contrast image after boundary extension, and obtaining the first registration result.

Furthermore, based on a preset maximum offset, the boundary extension may be performed on the contrast image in a symmetric mapping manner, i.e., on a boundary of the contrast image, pixel values of image symmetry may be used to fill an expanded region, and each side of the contrast image may be expanded to a maximum offset, so as to avoid a blank region appearing when the contrast image after global registration is translated and selected. Alternatively, the preset maximum offset may also be the above calculated offset. In other words, the boundary extension may be performed on the contrast image based on the offset corresponding to the optimal matching position.

After that, registration may be performed on the contrast image after boundary extension according to the calculated offset, i.e., the contrast image after the global registration. For example, when the distance between the optimal matching position in the mask image and the region of interest in the mask image is (1, 3), 1 represents a horizontal distance, and 3 represents a vertical distance, it may indicate that the offset of the current contrast image is (1, 3). In the contrast image after boundary extension, the offset (1, 3) may be applied to each pixel of the contrast image after boundary extension to obtain the contrast image after the global registration.

In the present embodiment, the offset corresponding to the optimal matching position may be determined, global registration may be performed on the mask image or the contrast image based on the offset to obtain the first registration result, so as to implement global registration of the mask image or the contrast image, and achieve effect of accurately correcting the image.

In some embodiments, performing the local registration on the image set after the global registration based on the first registration result, and obtaining the corresponding second registration result may further include: performing, based on the first registration result, block matching on the mask image and the contrast image after the global registration according to a preset image control point, obtaining a local region correspondence between the mask image and the contrast image after the global registration, performing, based on the local region correspondence, registration on the mask image and the contrast image after the global registration, and obtaining the corresponding second registration result. The local region includes the preset image control point.

Specifically, when the mask image is taken as the converting object, in the present embodiment, local registration may be performed on the mask image after the global registration and the contrast image by a pixel shift method. Firstly, a plurality of image control points may be selected from the mask image to determine key positions in the mask image, and block matching may be performed, according to each of the plurality of image control points, on the mask image after the global registration and the contrast image, so as to establish the local region correspondence between the mask image after the global registration and the contrast image.

Furthermore, a block image in the block matching of the local registration may be selected based on the plurality of image control points, i.e., each block image may include at least one image control point. Independent registration may be performed on each block image based on the at least one image control point, to obtain a local region correspondence between a plurality of block images in the mask image after the global registration and a plurality of block images in the contrast image, and the local region correspondence may include an offset of each pixel in each of the plurality of block images. The block image of the local registration may be smaller than that of the global registration. The offset of each pixel in each of the plurality of block images may be obtained in the local registration. In some embodiments, when a scanned part of the patient does not move, local region correspondences associated with different block images may be almost the same. In some embodiments, when the scanned part of the patient moves, local region correspondences associated with different block images may be different.

Furthermore, based on the local region correspondence between the mask image after the global registration and the contrast image, an offset corresponding to each pixel in the mask image after the global registration may be obtained by fitting. Each pixel in the mask image after the global registration may be adjusted to be aligned with that of the contrast image based on the offset to obtain the corresponding second registration result, i.e., the target mask image that completes global registration and local registration.

When the contrast image is taken as the converting object, in the present embodiment, local registration may be performed on the contrast image after the global registration and the mask image by a pixel shift method. Firstly, a plurality of image control points may be selected from the contrast to determine key positions in the contrast image, and block matching may be performed, according to each of the plurality of image control points, on the contrast image after the global registration and the mask image, so as to establish the local region correspondence between the contrast image after the global registration and the mask image.

Furthermore, a block image in the block matching of the local registration may be selected based on the plurality of image control points, i.e., each block image may include at least one image control point. Independent registration may be performed on each block image based on the at least one image control point, to obtain a local region correspondence between a plurality of block images in the contrast image after the global registration and a plurality of block images in the mask image, and the local region correspondence may include an offset of each pixel in each of the plurality of block images. The block image of the local registration may be smaller than that of the global registration. The offset of each pixel in each of the plurality of block images may be obtained in the local registration. In some embodiments, when a scanned part of the patient does not move, local region correspondences associated with different block images may be almost the same. In some embodiments, when the scanned part of the patient moves, local region correspondences associated with different block images may be different.

Furthermore, based on the local region correspondence between the contrast image after the global registration and the mask image, an offset corresponding to each pixel in the contrast image after the global registration may be obtained by fitting. Each pixel in the contrast image after the global registration may be adjusted to be aligned with that of the mask image based on the offset to obtain the corresponding second registration result, i.e., the target contrast image that completes global registration and local registration.

In the present embodiment, local registration may be performed on the image set after the global registration based on the first registration result to obtain the corresponding second registration result, so that local registration of the mask image or the contrast image may be implemented, and image artifacts caused by patient movement may be effectively eliminated.

In some embodiments, performing subtraction on the image set after the local registration based on the second registration result, and obtaining the subtraction image of the target portion may further include: splicing a plurality of contrast images into an overall image of the target portion, performing subtraction on the overall image based on the second registration result, and obtaining the subtraction image of the target portion. There are a plurality of collected positions, which are corresponding to a plurality of mask images and a plurality of contrast images, respectively. Alternatively, performing subtraction on the image set after the local registration based on the second registration result, and obtaining the subtraction image of the target portion further includes: performing, based on the second registration result, subtraction on the plurality of contrast images, splicing the plurality of contrast images after subtraction, and obtaining the subtraction image of the target portion.

Specifically, in the present embodiment, subtraction and splicing of the plurality of contrast images may be completed in different processing manners, so as to acquire the overall image of the target portion. Exemplarily, the plurality of contrast images may be spliced into the overall contrast image of the target portion according to the plurality of collected positions corresponding to the plurality of contrast images, a plurality of target mask images corresponding to the plurality of collected positions may be spliced into an overall mask image, and the subtraction may be performed on the overall contrast image based on the overall mask image, to obtain an overall subtraction image.

In addition, the target mask image and the contrast image corresponding to each of the plurality of collected positions may be pre-determined. Each time subtraction may be performed on the target mask image and the contrast image at the same collected position, so as to obtain a plurality of contrast images after subtraction, and then the plurality of contrast images after subtraction may be spliced to obtain the overall subtraction image of the target portion.

Alternatively, performing subtraction on the image set after the local registration based on the second registration result, and obtaining the subtraction image of the target portion may further include: splicing a plurality of mask images into an overall image of the target portion, performing subtraction on the overall image based on the second registration result, and obtaining the subtraction image of the target portion. There are a plurality of collected positions, which are corresponding to a plurality of mask images and a plurality of contrast images, respectively. Alternatively, performing subtraction on the image set after the local registration based on the second registration result, and obtaining the subtraction image of the target portion may further include: performing, based on the second registration result, subtraction on the plurality of mask images, splicing the plurality of mask images after subtraction, and obtaining the subtraction image of the target portion.

Specifically, in the present embodiment, the overall image of the target portion may be acquired in different processing manners. Exemplarily, the plurality of mask images may be spliced into the overall mask image of the target portion according to the plurality of collected positions corresponding to the plurality of mask images, a plurality of target contrast images corresponding to the plurality of collected positions may be spliced into an overall contrast image, and the subtraction may be performed on the overall mask image based on the overall contrast image, to obtain an overall subtraction image.

In addition, the target contrast image and the mask image corresponding to each of the plurality of collected positions may be pre-determined. Each time subtraction may be performed on the target contrast image and the mask image at the same collected position to obtain a plurality of mask images after subtraction, and then the plurality of mask images after subtraction may be spliced to obtain the overall subtraction image of the target portion.

It should be learned that the target mask image or the target contrast image obtained by global registration and local registration has corrected an offset generated in an image collecting process, so as to avoid relatively large difference between the mask image and the contrast image, thereby effectively improving a successful probability of image splicing.

In the present embodiment, subtraction may be performed on the image set after the local registration based on the second registration result to obtain the subtraction image of the target portion, so as to eliminate a motion artifact generated in the image collecting process and significantly improve quality of the subtraction image.

The following describes and explains the present embodiment by an alternative embodiment.

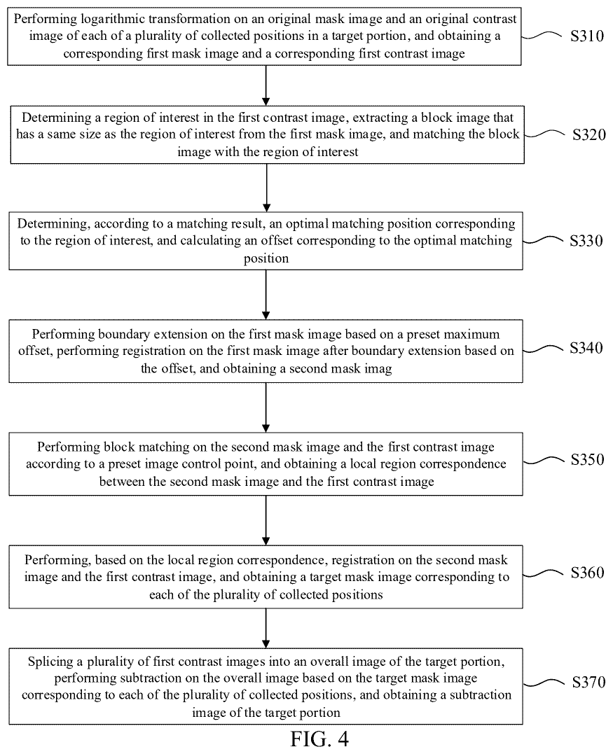

FIG. 4 is a flowchart of a method for artifact removal of a medical image in the alternative embodiment. Referring to FIG. 4, the method for artifact removal of the medical image may include step 310 to step 370.

Step 310 may include that performing logarithmic transformation on an original mask image and an original contrast image of each of a plurality of collected positions in a target portion, and obtaining a corresponding first mask image and a corresponding first contrast image.

Step 320 may include that determining a region of interest in the first contrast image, extracting a block image that has a same size as the region of interest from the first mask image, and matching the block image with the region of interest.

Step 330 may include that determining, according to a matching result, an optimal matching position corresponding to the region of interest, and calculating an offset corresponding to the optimal matching position.

Step 340 may include that performing boundary extension on the first mask image based on a preset maximum offset, performing registration on the first mask image after boundary extension based on the offset, and obtaining a second mask image.

Step 350 may include that performing block matching on the second mask image and the first contrast image according to a preset image control point, and obtaining a local region correspondence between the second mask image and the first contrast image.

Step 360 may include that performing, based on the local region correspondence, registration on the second mask image and the first contrast image, and obtaining a target mask image corresponding to each of the plurality of collected positions.

Step 370 may include that splicing a plurality of first contrast images into an overall image of the target portion, performing subtraction on the overall image based on the target mask image corresponding to each of the plurality of collected positions, and obtaining a subtraction image of the target portion.

In the present embodiment, logarithmic transformation may be performed on the original mask image and the original contrast image of each of the plurality of collected positions in the target portion to obtain the corresponding first mask image and the corresponding first contrast image, so as to convert the image from the exponential field to the linear field. Based on this, the region of interest in the first contrast image may be determined, the first mask image may be matched with the region of interest, and the offset of the first mask image may be acquired according to the matching result, so that registration may be performed on the first mask image after boundary extension based on the offset, so as to correct an image offset caused by factors such as rack shaking.

Furthermore, local registration may be performed on the second mask image and the first contrast image, to obtain the target mask image corresponding to each of the plurality of collected positions. The plurality of first contrast images may be spliced into an overall contrast image of the target portion, the plurality of target mask images corresponding to the plurality of collected positions may be spliced into an overall mask image, and the subtraction may be performed on the overall contrast image based on the overall mask image, to obtain the subtraction image of the target portion. This may resolve a problem that artifacts in the DSA image cannot be effectively removed, thereby implementing artifact removal of the images and improving quality of the vessel image.

It should be noted that the steps shown in the above process or in the flowchart of the accompanying drawings may be performed in a computer system such as a set of computers that can execute instructions. Although a logical sequence is shown in the flowchart, in some cases the steps shown or described may be performed in a different sequence.

In the present embodiment, an apparatus for artifact removal of a medical image is further provided, and the apparatus is configured to implement the foregoing embodiments and alternative implementations. Details are not described again. The terms “module”, “unit”, “subunit”, and the like used in the following may implement a combination of software and/or hardware of a preset function. Although the apparatus described in the following embodiments is preferably implemented in software, implementation of hardware, or a combination of software and hardware, is possible and conceived.

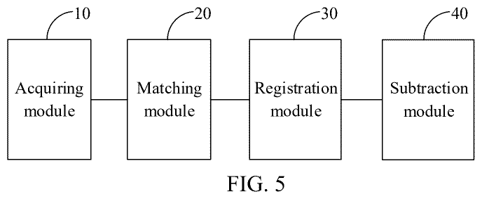

FIG. 5 is a schematic diagram of an apparatus for artifact removal of a medical image in an embodiment. Referring to FIG. 5, the apparatus includes an acquiring module 10, a matching module 20, a registration module 30, and a subtraction module 40.

The acquiring module 10 is configured for acquiring an image set of a collected position in a target portion. The image set includes a mask image and a contrast image in one-to-one correspondence.

The matching module 20 is configured for performing global registration on the mask image and the contrast image of the collected position, and obtaining a first registration result.

The registration module 30 is configured for performing local registration on the image set after the global registration based on the first registration result, and obtaining a corresponding second registration result.

The subtraction module 40 is configured for performing subtraction on the image set after the local registration based on the second registration result, and obtaining a subtraction image of the target portion.

In some embodiments, based on the FIG. 5, the apparatus may further include a preprocessing module. The mask image is a preprocessed mask image, the contrast image is a preprocessed contrast image, and a preprocessing in the preprocessing module includes at least one of logarithmic transformation, regularization, normalization, or denoising processing.

In some embodiments, based on the FIG. 5, the matching module 20 may further include a global registration module. The global registration module is configured for performing the global registration on the mask image and the contrast image of the collected position, and obtaining the first registration result further includes: determining a region of interest in the contrast image, extracting a block image that has a same size as the region of interest in the contrast image from the mask image, matching the block image of the mask image with the region of interest in the contrast image, determining, according to a matching result, an optimal matching position corresponding to the region of interest in the contrast image, determining an offset corresponding to the optimal matching position, performing the global registration on the mask image based on the offset, and obtaining the first registration result. Alternatively, the global registration module is configured for performing the global registration on the mask image and the contrast image of the collected position, and obtaining the first registration result further includes: determining a region of interest in the mask image, extracting a block image that has a same size as the region of interest in the mask image from the contrast image, matching the block image of the contrast image with the region of interest in the mask image, determining, according to a matching result, an optimal matching position corresponding to the region of interest in the mask image, determining an offset corresponding to the optimal matching position, performing the global registration on the contrast image based on the offset, and obtaining the first registration result.

In some embodiments, based on the FIG. 5, the global registration module may further include a screening module. The screening module is configured for determining a target region in the contrast image according to the target portion, and taking the target region in the contrast image as the region of interest in the contrast image; or determining the region of interest in the contrast image based on information degree of each local region in the contrast image. Alternatively, the screening module is configured for determining a target region in the mask image according to the target portion, and taking the target region in the mask image as the region of interest in the mask image; or determining the region of interest in the mask image based on information degree of each local region in the mask image.

In some embodiments, based on the FIG. 5, the global registration module may further include a searching module. The searching module is configured for processing the mask image by an image searching algorithm, obtaining a plurality of block images of the mask image with the same size as the region of interest in the contrast image, and matching each of the plurality of block images in the mask image with the region of interest in the contrast image. Alternatively, the searching module is configured for processing the contrast image by the image searching algorithm, obtaining a plurality of block images of the contrast image with the same size as the region of interest in the mask image, and matching each of the plurality of block images of the contrast image with the region of interest in the mask image.

In some embodiments, based on the FIG. 5, the global registration module may further include an extending module. The extending module is configured for performing boundary extension on the mask image based on a preset maximum offset, performing, based on the offset corresponding to the optimal matching position, registration on the mask image after the boundary extension, and obtaining the first registration result. Alternatively, the extending module is configured for performing boundary extension on the contrast image based on a preset maximum offset, performing, based on the offset corresponding to the optimal matching position, registration on the contrast image after the boundary extension, and obtaining the first registration result.

In some embodiments, based on the FIG. 5, the registration module 30 is further configured for performing, based on the first registration result, block matching on the mask image and the contrast image after the global registration according to a preset image control point, obtaining a local region correspondence between the mask image and the contrast image after the global registration, performing, based on the local region correspondence, registration on the mask image and the contrast image after the global registration, and obtaining the corresponding second registration result. The local region includes the preset image control point.

In some embodiments, based on the FIG. 5, the subtraction module 40 is further configured for splicing a plurality of contrast images into an overall image of the target portion, performing subtraction on the overall image based on the second registration result, and obtaining the subtraction image of the target portion; or performing, based on the second registration result, subtraction on the plurality of contrast images, splicing the plurality of contrast images after subtraction, and obtaining the subtraction image of the target portion. There are a plurality of collected positions, which are corresponding to a plurality of mask images and a plurality of contrast images, respectively. Alternatively, the subtraction module 40 is further configured for performing subtraction on the image set after the local registration based on the second registration result, and obtaining the subtraction image of the target portion further includes: splicing the plurality of mask images into an overall image of the target portion, performing subtraction on the overall image based on the second registration result, and obtaining the subtraction image of the target portion; or performing, based on the second registration result, subtraction on the plurality of mask images, splicing the plurality of mask images after subtraction, and obtaining the subtraction image of the target portion.

It should be noted that the foregoing modules may be functional modules or program modules, and may be implemented by software or hardware. For modules implemented by hardware, the foregoing modules may be located in a same processor. Alternatively, the foregoing modules may be located at different processors in any combination.

In an embodiment, a computer device is further provided, including a memory and a processor. The memory stores a computer program, and the processor is configured to run the computer program to execute the steps in any one of the foregoing method embodiments.

Alternatively, the foregoing computer device may further include a transmission device and an input/output device, the transmission device is connected to the foregoing processor, and the input/output device is connected to the foregoing processor.

It should be noted that for a specific example in the present embodiment, reference may be made to the example described in the foregoing embodiment and the alternative implementation, and details are not described in the present embodiment.

In addition, with reference to the method for artifact removal of the medical image provided in the foregoing embodiment, a storage medium is further provided. A computer program is stored in the storage medium. When the computer program is executed by a processor, the method for artifact removal of the medical image in the foregoing embodiment is implemented.

It should be understood that a specific embodiment described herein is merely used to explain the present disclosure, but is not used to limit the present disclosure. According to the embodiments provided in present disclosure, all other embodiments obtained by one skilled in the art without creative efforts fall within the protection scope of the present disclosure.

It is obvious that the accompanying drawings are merely some examples or embodiments of the present disclosure. One skilled in the art may also apply the present disclosure to another similar case according to these accompanying drawings, but no creative effort is required. In addition, it may be understood that, although work performed in a development process may be complex and lengthy, for one skilled in the art, some changes such as design, manufacture, or production that are made according to technical content disclosed in the present disclosure are merely conventional technical means, and should not be considered as deficiencies disclosed in the present disclosure.

The term “embodiment” in the present disclosure refers to that a specific feature, structure, or feature described with reference to the embodiments may be included in at least one embodiment of the present disclosure. Each location of the phrase appearing in the specification does not necessarily mean the same embodiment, nor does it mean that the phrase is mutually exclusive and independent or optional with another embodiment. One skilled in the art can clearly or implicitly understand that the embodiments described in the present disclosure may be combined with other embodiments in a case there is no conflict.

The foregoing embodiments represent only several implementation manners of the present disclosure, and descriptions thereof are relatively specific and detailed, but may not be construed as a limitation on the scope of patent protection. It should be noted that one skilled in the art may make some modifications and improvements without departing from the concept of the present disclosure, which are within the protection scope of the present disclosure. Therefore, the protection scope of the present disclosure shall be subject to the attached claims.

What is claimed is:

1. A method for artifact removal of a medical image, comprising:
acquiring an image set of a collected position in a target portion, wherein the image set comprises a mask image and a contrast image in one-to-one correspondence;
performing global registration on the mask image and the contrast image of the collected position, and obtaining a first registration result;
performing local registration on the image set after the global registration based on the first registration result, and obtaining a corresponding second registration result; and
performing subtraction on the image set after the local registration based on the second registration result, and obtaining a subtraction image of the target portion.

2. The method of claim 1, wherein the mask image is a preprocessed mask image, the contrast image is a preprocessed contrast image, and a preprocessing comprises at least one of logarithmic transformation, regularization, normalization, or denoising processing.

3. The method of claim 1, wherein performing the global registration on the mask image and the contrast image of the collected position, and obtaining the first registration result further comprises:
determining a region of interest in the contrast image;
extracting a block image that has a same size as the region of interest in the contrast image from the mask image, and matching the block image of the mask image with the region of interest in the contrast image;
determining, according to a matching result, an optimal matching position corresponding to the region of interest in the contrast image; and
determining an offset corresponding to the optimal matching position, performing the global registration on the mask image based on the offset, and obtaining the first registration result;
alternatively, performing the global registration on the mask image and the contrast image of the collected position, and obtaining the first registration result further comprises:
determining a region of interest in the mask image;
extracting a block image that has a same size as the region of interest in the mask image from the contrast image, and matching the block image of the contrast image with the region of interest in the mask image;
determining, according to a matching result, an optimal matching position corresponding to the region of interest in the mask image; and
determining an offset corresponding to the optimal matching position, performing the global registration on the contrast image based on the offset, and obtaining the first registration result.

4. The method of claim 3, wherein determining the region of interest in the contrast image further comprises:
determining a target region in the contrast image according to the target portion, and taking the target region in the contrast image as the region of interest in the contrast image; or
determining the region of interest in the contrast image based on information degree of each local region in the contrast image;
alternatively, determining the region of interest in the mask image further comprises:
determining a target region in the mask image according to the target portion, and taking the target region in the mask image as the region of interest in the mask image; or
determining the region of interest in the mask image based on information degree of each local region in the mask image.

5. The method of claim 3, wherein extracting the block image that has the same size as the region of interest in the contrast image from the mask image, and matching the block image of the mask image with the region of interest in the contrast image further comprises:
processing the mask image by an image searching algorithm, and obtaining a plurality of block images of the mask image with the same size as the region of interest in the contrast image; and
matching each of the plurality of block images of the mask image with the region of interest in the contrast image;
alternatively, extracting the block image that has the same size as the region of interest in the mask image from the contrast image, and matching the block image of the contrast image with the region of interest in the mask image further comprises:
processing the contrast image by the image searching algorithm, and obtaining a plurality of block images of the contrast image with the same size as the region of interest in the mask image; and
matching each of the plurality of block images of the contrast image with the region of interest in the mask image.

6. The method of claim 3, wherein determining the offset corresponding to the optimal matching position, performing the global registration on the mask image based on the offset, and obtaining the first registration result further comprises:
applying the offset to each pixel in the mask image to obtain the first registration result;
alternatively, determining the offset corresponding to the optimal matching position, performing the global registration on the contrast image based on the offset, and obtaining the first registration result further comprises:
applying the offset to each pixel in the contrast image to obtain the first registration result.

7. The method of claim 3, wherein determining the offset corresponding to the optimal matching position, performing the global registration on the mask image based on the offset, and obtaining the first registration result further comprises:
performing boundary extension on the mask image based on a preset maximum offset; and
performing, based on the offset corresponding to the optimal matching position, registration on the mask image after the boundary extension, and obtaining the first registration result;
alternatively, determining the offset corresponding to the optimal matching position, and performing the global registration on the contrast image based on the offset, and obtaining the first registration result further comprises:
performing boundary extension on the contrast image based on a preset maximum offset; and
performing, based on the offset corresponding to the optimal matching position, registration on the contrast image after the boundary extension, and obtaining the first registration result.

8. The method of claim 1, wherein performing the local registration on the image set after the global registration based on the first registration result, and obtaining the corresponding second registration result further comprises:
performing, based on the first registration result, block matching on the mask image and the contrast image after the global registration according to a preset image control point, and obtaining a local region correspondence between the mask image and the contrast image after the global registration, wherein the local region comprises the preset image control point; and
performing, based on the local region correspondence, registration on the mask image and the contrast image after the global registration, and obtaining the corresponding second registration result.

9. The method of claim 1, wherein performing subtraction on the image set after the local registration based on the second registration result, and obtaining the subtraction image of the target portion further comprises:
splicing a plurality of contrast images into an overall image of the target portion, performing subtraction on the overall image based on the second registration result, and obtaining the subtraction image of the target portion, wherein there are a plurality of collected positions, which are corresponding to a plurality of mask images and a plurality of contrast images, respectively; or
performing, based on the second registration result, subtraction on the plurality of contrast images, splicing the plurality of contrast images after subtraction, and obtaining the subtraction image of the target portion;
alternatively, performing subtraction on the image set after the local registration based on the second registration result, and obtaining the subtraction image of the target portion further comprises:
splicing the plurality of mask images into an overall image of the target portion, performing subtraction on the overall image based on the second registration result, and obtaining the subtraction image of the target portion; or
performing, based on the second registration result, subtraction on the plurality of mask images, splicing the plurality of mask images after subtraction, and obtaining the subtraction image of the target portion.

10. The method of claim 1, wherein acquiring the image set of the collected position in the target portion further comprises:
acquiring a plurality of frames of mask images and a plurality of frames of contrast images at a same collected position; and
performing the global registration on the mask image and the contrast image of the collected position, and obtaining the first registration result further comprises:
performing the global registration on each of the plurality of frames of mask images and each of the plurality of frames of contrast images to obtain a plurality of groups of mask images and contrast images after the global registration, calculating similarity between the mask image and the contrast image in each of the plurality of groups of mask images and contrast images, and selecting a mask image and a contrast image with the highest similarity as the mask image and the contrast image after the global registration at the collected position, respectively.

11. A method for artifact removal of a medical image, comprising:
acquiring a first mask image and a first contrast image of a collected position in a target portion;
performing global registration on the first mask image based on a region of interest in the first contrast image, and obtaining a second mask image;
performing local registration on the second mask image and the first contrast image, and obtaining a target mask image corresponding to the collected position; and
performing subtraction on the first contrast image based on the target mask image, and obtaining a subtraction image of the target portion.

12. The method of claim 11, wherein the first mask image is a preprocessed mask image, the first contrast image is a preprocessed contrast image, and a preprocessing comprises at least one of logarithmic transformation, regularization, normalization, or denoising processing.

13. The method of claim 11, wherein performing the global registration on the first mask image based on the region of interest in the first contrast image, and obtaining the second mask image further comprises:
determining the region of interest in the first contrast image;
extracting a block image that has a same size as the region of interest in the first contrast image from the first mask image, and matching the block image of the first mask image with the region of interest in the first contrast image;
determining, according to a matching result, an optimal matching position corresponding to the region of interest in the first contrast image; and
determining an offset corresponding to the optimal matching position, performing the global registration on the first mask image based on the offset, and obtaining the second mask image.

14. The method of claim 13, wherein determining the region of interest in the first contrast image further comprises:
determining a target region in the first contrast image according to the target portion, and taking the target region in the first contrast image as the region of interest in the first contrast image; or
determining the region of interest in the first contrast image based on information degree of each local region in the first contrast image.

15. The method of claim 13, wherein extracting the block image that has the same size as the region of interest in the first contrast image from the first mask image, and matching the block image of the first mask image with the region of interest in the first contrast image further comprises:
processing the first mask image by an image searching algorithm, and obtaining a plurality of block images of the first mask image with the same size as the region of interest in the first contrast image; and
matching each of the plurality of block images of the first mask image with the region of interest in the first contrast image.

16. The method of claim 13, wherein determining the offset corresponding to the optimal matching position, performing the global registration on the first mask image based on the offset, and obtaining the second mask image further comprises:
applying the offset to each pixel in the first mask image to obtain the second mask image.

17. The method of claim 13, wherein determining the offset corresponding to the optimal matching position, performing the global registration on the first mask image based on the offset, and obtaining the second mask image further comprises:
performing boundary extension on the first mask image based on a preset maximum offset; and
performing, based on the offset corresponding to the optimal matching position, registration on the first mask image after the boundary extension, and obtaining the second mask image.

18. The method of claim 11, wherein performing the local registration on the second mask image and the first contrast image, and obtaining the target mask image corresponding to the collected position further comprises:
performing block matching on the second mask image and the first contrast image according to a preset image control point, and obtaining a local region correspondence between the second mask image and the first contrast image, wherein the local region comprises the preset image control point; and
performing, based on the local region correspondence, registration on the second mask image and the first contrast image, and obtaining the target mask image corresponding to the collected position.

19. The method of claim 11, wherein performing subtraction on the first contrast image based on the target mask image, and obtaining the subtraction image of the target portion further comprises:
splicing a plurality of first contrast images into an overall contrast image of the target portion, performing subtraction on the overall contrast image based on the target mask image corresponding to each of a plurality of collected positions, and obtaining the subtraction image of the target portion, wherein the plurality of collected positions are corresponding to a plurality of target mask images and a plurality of first contrast images, respectively; or
performing, based on the plurality of target mask images, subtraction on the plurality of first contrast images, splicing the plurality of first contrast images after the subtraction, and obtaining the subtraction image of the target portion.

20. A DSA (Digital Subtraction Angiography) system, comprising a DSA device and a processing device, wherein the processing device is configured to implement the method of claim 1.
